(19) United States
(12) Patent Application Publication
(10) Pub. No.: US 2020/0396531 A1
(43) Pub. Date: Dec. 17, 2020

(54) SYSTEM AND METHOD BASED IN ARTIFICIAL INTELLIGENCE TO DETECT USER INTERFACE CONTROL COMMAND OF TRUE WIRELESS SOUND EARBUDS SYSTEM ON CHIP,AND THEREOF

(71) Applicant: Abhivarman Paranirupasingam, Toronto (CA)

(72) Inventor: Abhivarman Paranirupasingam, Toronto (CA)

(21) Appl. No.: 17/005,520

(22) Filed: Aug. 28, 2020

(51) Int. Cl. H04R 1/10; G06F 3/16; G06N 3/08

(52) U.S. Cl. CPC H04R 1/1041; H04R 1/1016; H04R 2420/07; G06N 3/08; G06F 3/165

(57) ABSTRACT

In This invention we are going to present a solution that replace the need of external integrated circuit to manage user interface control of True wireless sound, without compromised the audio signal quality and taking advantage of the radio frequency chipset core, by update the firmware to recognize user interface control sequences by reading both reading power signal of each direction of RF inline with Smartware AI core.

### FIELD OF THE INVENTION

This inventions relates to a system and method based in artificial intelligence to detect user interface control command for true wireless sound earbuds, by eliminating the usage of switch button and/or any external integrated circuit such touch circuit, such accelerometer, by monitoring the time slot of radio frequency and it signal power during the operation.

### SUMMARY OF PRIOR ART

Nowadays True wireless sound (TWS) and/or earbuds, are increasingly focus in Sound quality, sound optimization and many other features, and could be presented in different design. However no one of TWS and/or earbuds maker take account about implementing Artificial intelligence for user control without using external integrated circuit and/or switch button. Different maker of true wireless sound, as reference but not limited; Apple, Samsung, Beats, etc . . . , they are using different Sound SoC chipset such Qualcom, Realtek, Apple etc . . . . The common function between all true wireless sound earbuds maker when it comes to user interface control; Volume control; Answers call and more control states, they're based in one of this methods: (1) mechanical button based in human force to press depends on requirements, (2) interfacing accelerometer to detect how many taps user did, (3) Interface Integrated circuit to calculate human finger capacitance and checking it activities through probing plates that could be flexible or rigid, (4) interface small TX/RX RF monitoring for contact-less activities monitoring over air and Finally Voice command control.

To address this issue, those skilled in the art have proposed many solutions to be used as external module interfaced as external components which increase the cost, and will have limited states control when it comes to button control and/or capacitance control and/or using accelerometer, when it comes to voice control method and/or TX/RX RF radar array, both it requires high SoC and/or DSP handle that without provides any latency, all above listed increase the cost of true wireless sound earbuds, and their control method state updates require firmware release each time new control method added.

Other techniques that have been proposed to control user commands of true wireless sound is to use mobile device application to updates many commands control status but this will require more development in mobile application and is not convenient for all users.

Another techniques that have been proposed is to interface small electronic ring that paired with true wireless sound earbuds, to give user more freedom of control, but it always in term of cost still costly and require more human resources to main updates of design portability to different environments.

In the view of the above, it is most desirous for a technique to derive a robust system and method to ensure easy integration of the system control, lowest cost of production and portability of the solution to any different architecture platforms.

For those above reasons, those skilled in the art are constantly striving to come up with a system and method that is capable to be integrated inside True wireless sound and/or earbuds solution and give more freedom of user control of their earbuds, inline with interfacing Artificial intelligence in form of tiny machine learning algorithm to be executed in any platform and using the radio frequency controller as sensors tools of user control commands.

### SUMMARY OF THE INVENTION

The above and other bottleneck problems are solved and an advance in the prior art is made by system and method described by embodiment's in accordance with the invention.

A first advantage of embodiments of system and method in accordance with the invention that the system is placed with true wireless sound and/or earbuds in format of portable embedded firmware that require limited space of RAM and very limited space in flash footprint.

A second advantage of embodiments of system and method according to the invention is that that maker could reduce the cost of manufacturing and mass production cycle from 10% to more than 50%, by eliminating interfacing external control IC, or by require high level SoC and/or DSP.

A third advantage of embodiment's of system and method in accordance with the invention is that regardless of the used DSP and/or MCU of true wireless sound earbuds it don't require special porting or specific architecture to run from it.

A fourth advantage of embodiment's of system and method in accordance with the invention that the True wireless sound and/or earbuds; the only factors that required is radio frequency; (1) TX power of transmitting (2) RX received power (3) Data rate (4) Modulation (5) channel usage (6) Frequency Band, which this variable is collected from the true wireless sound ear-bud chipset maker at the time of mass production, by access to their relevant registers through firmware application.

A fifth advantage of embodiment's of system and method in accordance to the invention regardless the user condition and/or weather and/or time day user still able to detect user control interface with precision and ultra low false rate.

A sixth advantage of embodiment's of system and method in accordance to the invention regardless the user, the TWS and/or earbuds MCU will be able to detect any variation fo sequences in environment by analyzing the the factors used in he's configuration and with the machine learning to identify each sequence and convert it to control sequence.

A seventh advantage of embodiment's of system and method in accordance to the invention, regardless the chipset architecture the maker will be able to use he's own SoC and/or DSP as user interface control without need to use external control module or integrated control module at Asic level.

The above advantage are provided by embodiment's of a system and method in accordance with the invention operating in the following manner.

According to a first aspect of the invention, a system for converting user sequence to control sequence by using the True wireless sound earbuds chipset itself as user interface control sensor by integrated artificial intelligence algorithm compromising: mobile device of the user and pair of TWS and/or earbuds units; and a radio frequency signal core to read radio frequencies spectrum based in factors listed above at fourth advantage, and applying different neural network algorithm that could be embedded at bare level of DSP as hardware module or implemented as firmware coding style targeting different language of programming, the method compromise deep learning algorithm method, configuration of machine learning and sequence recognition; First the data need to be trained by collecting the data from Radio frequency chipset by reading their registers relates to TX outout power, RX received power and Data rate, this variable is changing in linear with the time series; Data is sampled at steps of period of time selected by the user input that varie from one nano-second to 50 ms, each time user has different control command to do it should be first sampled for time window of one second; along with the input attributes a fixed variable that define Modulation, channel, and frequency will be calculated by a data error factor correction this will adjust level of sampling to have accurate data in time series; the final bytes going to be filtered for each attributes in parallel or cascade modes depends on user settings; the result of each attributes is presented as cleaned signal, this signal has different peaks in time series and it going to be split in small block to detect confidence level of changes for each transition, this transition will be created by complex algorithm that identify timeline of change start and end, maximum peak and minimum peak to build confident boundary and threshold, this output bitmap will be a guide instruction decision for features extracting.

Within reference to the first aspect, the generated bitmaps for the input attributes that sampled during the time series; will be defined as input layers dimension for the machine learning algorithm, along with the target output layer that user need to define it based in user control sequence that is trying to train it the the moment of sampling.

Within reference to the first aspect, the defined inputs and outputs layer for each control sequence, will be handled by the machine learning algorithm; the machine learning algorithm will define the optimum training method, and the optimum activation for each layers and each hidden layers; in reference with other factors as learning factor, step optimization.

Within reference to the first aspect, after the training of all sequences that user target to do it, a neural network file will be generated based in trained sequences that contain mean square error of the network; and bit fail error limits; and activation values; error factors correction of each layers; the generated neural network will be the the neural brain of the machine learning for the true wireless sound earbuds to predict machine sequence and convert it to control command.

According to a second aspect of the invention, a method to convert True wireless sound system on chip, to detect user interface control using Artificial neural network, the method compromising the steps of: sampling the status register from the SoC itself for; Radio frequency Power for received signal and transmitted signal, and data rate, with a specific period of time and/or between window Scan during the pairing of the True wireless sound earbuds device; the sampled data will be filtered using series of mathematics calculus called Kalman filter; the filtered data will be posted to a function called features extraction, the extracted features will be converted to a finite state machine and each state machine has a it own a specific input attributes; Ai function will handle the input data as input layers, inline by calling the neural network file settings which it hold different initial variable that already calculated at the trained level which is disclosed; the general result from the Artificial neural network function will be handle by a prediction function which it compared the mean square error of network and actual value and mean square error of the target output prediction of the state machine, the classified data of the sampled data will be presented as percentage level to identify if the target class label that user is targeting it has great similarity with the user interface control command that presented by the user of the True wireless sound earbuds devices; based in the final class that has high chance that more than 50% and close to 100% the System on Chip of the True wireless system earbuds will call the corresponding function to do e.g: volume up/Volume down, Mute and So on.

With reference to the second aspect, the classification will be defined by the True wireless sound earbuds maker depends in how many user control interface command want to integrated to the device.

With reference to the second aspect, True wireless sound earbuds maker will get information of input layers by access to SoC register map that he defined about he's own radio frequency core.

With reference to the second aspect, the neural network file and/or settings variable will be including in the true wireless sound earbuds maker during the mass production of their firmware flashing.

With reference to the second aspect, when the Artificial neural network algorithm will be integrated as firmware to any architecture defined by the true wireless sound earbuds maker, and small area inside the flash maps should be defined to cover Ai functions.

With reference to the second aspect, before start sampling the data maker of true wireless sound earbuds firmware developer need to define all location of the radio frequency register maps, to recognize all inputs variables.

Within reference to second aspect, the final decision of class prediction is based in true wireless sound earbuds maker threshold definition, maker has freedom to define it own threshold.

### BRIEF DESCRIPTION OF THE DRAWINGS

FIG. 1: Flow chart diagram explanation of neural network training.

FIG. 2: Flow chart diagram of the system used at low level of True wireless sound earbuds chipset.

FIG. 3: Artificial intelligence implementation at firmware register maps.

FIG. 4: Data Plot sampling example of received signal power versus Time series.

FIG. 5: Diagram shows user interface command control recognition steps.

### DETAILS DESCRIPTION

This invention relates to a system and method based in artificial intelligence to detect user interface control command of true wireless sound earbuds system on chip. In particular the system and method sample Radio frequency power for transmitter and receiver inline with data rate versus a time series, by taking the error factor that relates to radio frequency modulation, channel bands and frequencies bandwidth. The samples data will be filter to remove all noises, this is preparation to build high precise bitmap tables to extract features. All features will be trained based in state machine, using trained machine software tools. The generated trained data-set will be used to convert the true wireless sound earbuds system on chip on user interface control.

The present invention will now be described in detail with reference to several embodiment's thereof as illustrated in the accompanying drawings. Further, one skilled in the art will recognize that many functional units in this descriptions have been identified as module throughout the specification. The person skilled in the will also recognize that a module maybe implemented as circuits, firmware module or any sort of asic modules. The choice of the implementation of the module is left as a design choice to a developer skilled in the art and does not limit the scope of the invention in anyway.

An exemplary process or method for training, sampling and classification of user control command in accordance with embodiment's of the invention is set out in steps below. The step of the process or method are as follows:

Step 1: User train different user command interface for different sequence by sampling the data, and generate trained network file.

Step 2: User include the trained network file during the compile of he's own firmware.

Step 3: True wireless sound earbuds system on chip become autonomous to detect user interface command while power on Cycle.

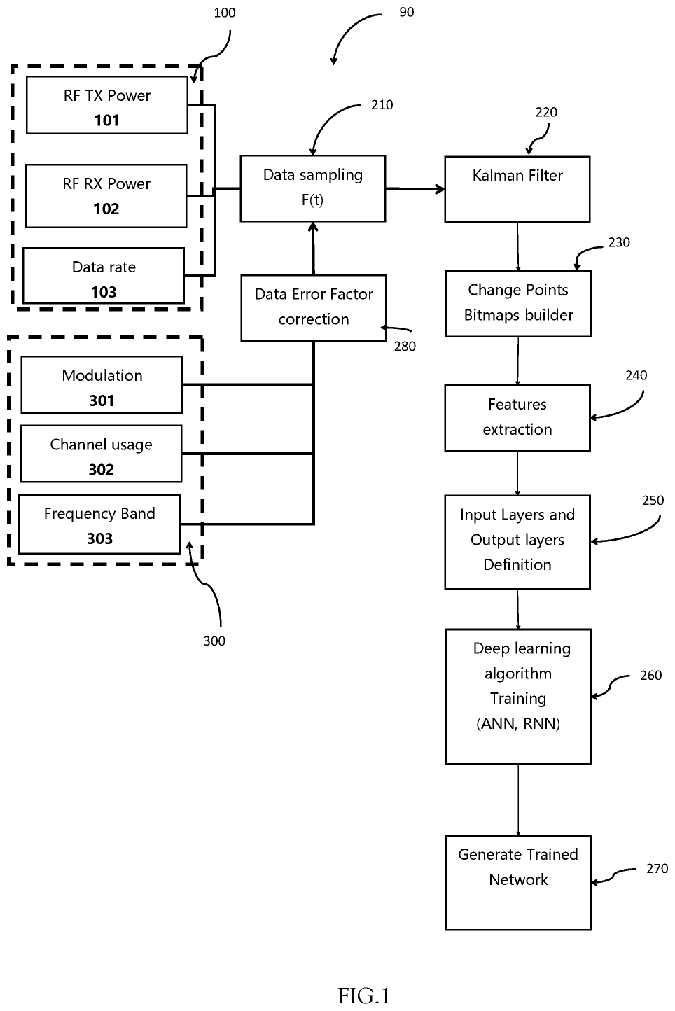

In accordance with embodiments of the invention, the step 1 maybe performed by modules contained within deep learning software module or hardware module, as illustrated in FIG. 1, whereby the deep learning core 90 compromises different modules; where:

Data values 100, are then received by data sampling module 210, the sampling will include register value each time the data is sample where this values is identified; received radio frequency power 101, transmitted frequency power 102 and Data rate 103. During the sampling by the module 210, external factor is calculated Data error factor correction 280 this module it help sample data correctly by eliminating unwanted data, the error factor is calculated based in three variable; Modulation 301 of frequency, channel usage 302 and frequency band. The Data sampling 210 is time series function for non-linear application, the output of sampled data will be filtered by Kalman filter 220 module, after the data filtered and buffered another module will calculate the change points bitmap builder 230, during the training the user could interact with the true wireless sound chip-set to teach the machine about different control commands, for that features extract 240 module is required to output unique features of each action to the next module, which user could define the input layers and output layers definition 250. In embodiments of the invention, deep learning module 260, will be start the run time based in the user settings and target accuracy, after the training finished a module generate trained network file 270, will create unique files that contains different parameters relates to the selected neural network file type, layers and mean square error for the network.

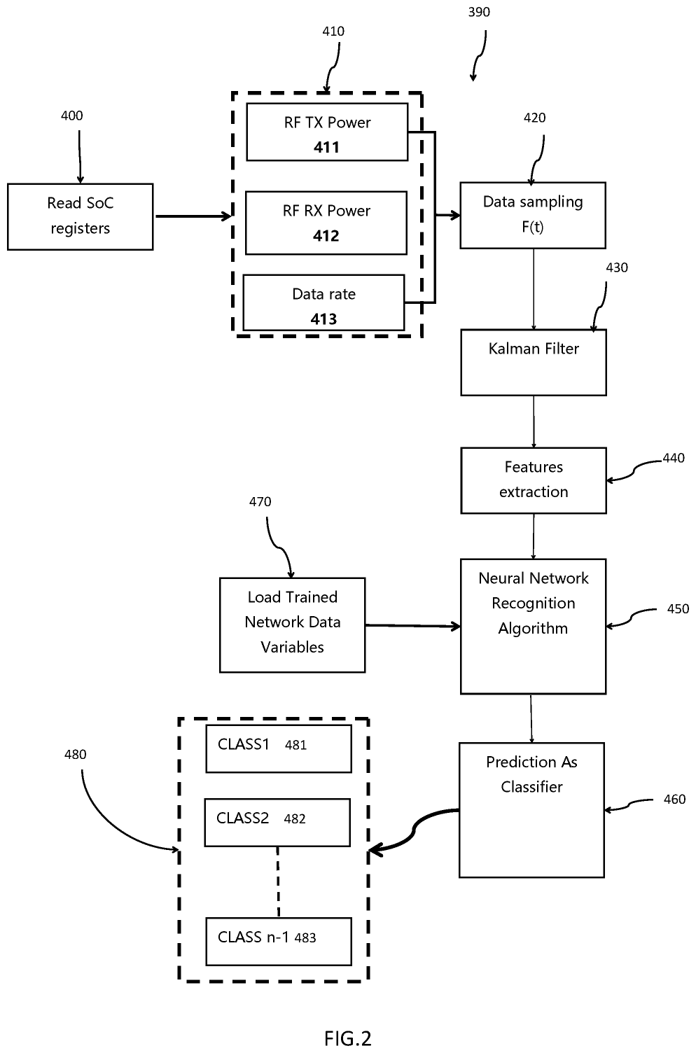

In accordance with embodiments of the invention, a block diagram representative of components that may be provided with Chipset maker firmware and/or ASIC module 390 (as illustrated in the FIG. 2) for implementing embodiments in accordance. One skilled in the art will recognize that the configuration of user interface recognition core 390 is not fixed and may be different and may vary. In embodiments of the invention, module 400 is function and/or Hardware accelerated module to read periodically the internal register area 410, this area contain; radio frequency transmitter power 411, radio frequency receiver power 412 and date rate 413, when the data from register ready for read the module data sampling 420, in accordance with with FIG. 1, the modules includes in FIG. 2 share same functions as Core 90 in FIG. 1, except the Core 390 in FIG. 2 is used at chipset level after training done at system level as explained in core 90 in FIG. 1. The Kalman filter 430 in core 390 in FIG. 2, is real time function to filter repeated data and unwanted data samples as time series, after filtering is done, data passed to feature extract 440, each sequence of user command has it unique features and will extracted, the time it extracted the module neural network recognition algorithm 450 change it state from Standby to Ready to process data coming from module 440 however before the data will proceed the

module 450 load the trained network file that already stored in flash area of Chipset of maker from the load trained network data variable 470 all variable ready now the Artificial intelligence core which is presented 390 will start prediction about the sequence of user control by using the sub module prediction as classifier 460 the detection will take between couples of of hundred of nano seconds or less depends on chipset speed, after the sequence detected, the result will comes estimation percentage of where this sequence it belong depends on user training sequences which will be presented in the module classes 480 where instances CLASS1 481, CLASS2 482 and CLASSn−1 483, represented different prediction based in user or chip maker definition classes.

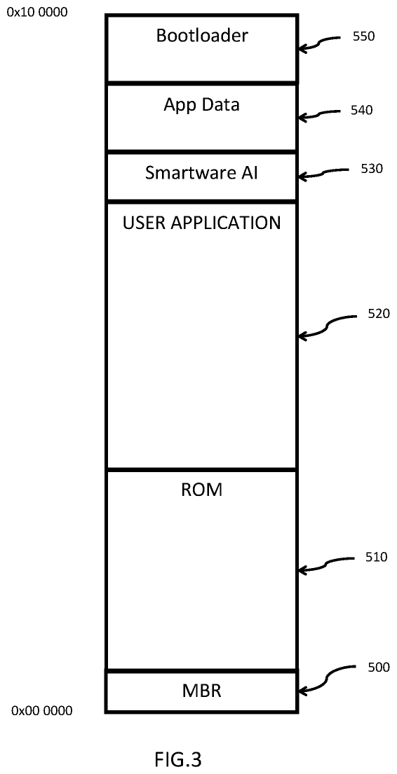

In accordance with embodiment's of the invention, a block diagram representative of smartware Ai core that may be provided with Chipset maker firmware (as illustrated in the FIG. 3) for implementing embodiment's in accordance. One skilled in the art will recognize that the configuration of smartware AI 530 in FIG. 3. In FIG. 3 it shows reference structure of firmware but not limited, where the master boot record 500 is initial firmware for the chipset maker, the ROM 510 is the true wireless sound maker personalized settings where he could include all variable settings of neural network algorithm, the user application 520 where it include call back function to call Smartware AI 530 to process the data and predict user interface control commands, inline with App Data 540 where it could contain more trained or depends in user or chipset maker settings, the boot-loader 550 is small piece of code placed at the bottom where user or chipset maker could use it to update the Smartware AI 530, without re-flashing the whole firmware.

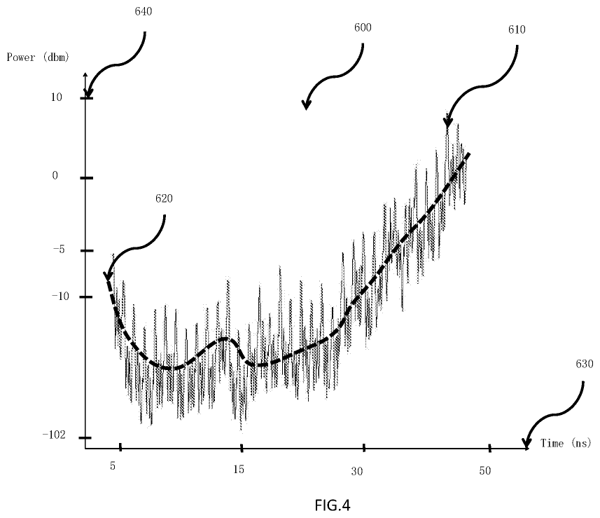

In accordance with embodiment's of the invention, FIG. 4 represented example of graph 600 where the sampled data 610 of received or transmitted power radio frequency where the axis Y 640 represent signal level and Axis X 630 represent time series, where the sampled data will be filtered and presented as Signal clean line 620, where this module is common module at training sage in FIG. 1, and Artificial intelligence core FIG. 2.

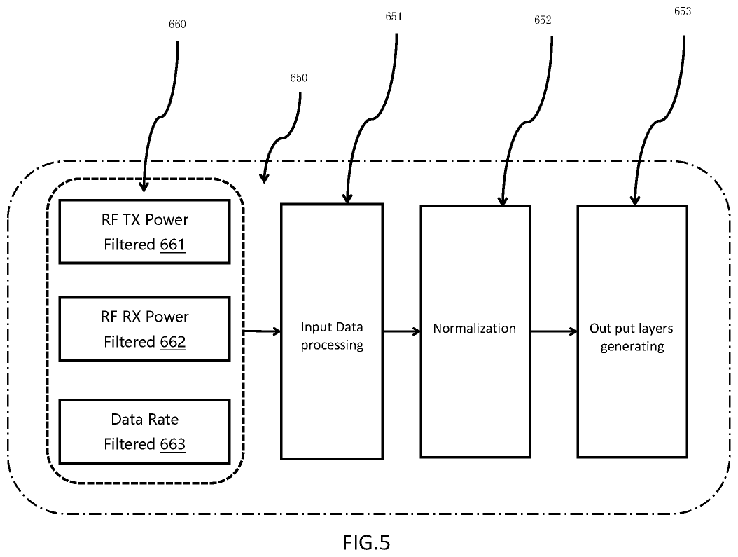

In accordance with embodiment's of the invention, FIG. 5 represented the Smartware Ai Core 650, where is common core for training and chipset level. Further, one skilled in the art will recognize that many functional units in this descriptions have been identified as module throughout the specification and could be user as firmware and/or ASIC hardware module where the Firmware could be converted to RTL and from that to ASIC. However the core 650 is composed: Front end Module 660 where the register access to read signal power and/or data rate count of sub modules: radio frequency transmitted power filtered 661, radio frequency received power filtered 662 and data rate filtered 663; all this variable could be stored inside SRAM temporary or any FIFO, as skilled person know how to manage this variables, the front end 660 pass this buffers to Pre-post module called input data processing 651 where the all buffer will placed in table according to their received time series, without limitation to specific CPU and/or MCU architecture normalization module 652, could handle the data where 8 bits Architecture is evolved to minimize RAM usage down scale 32 bit float data to 8 bits data, inline with received data from previous module the output layer generating 653, will automatically generated target class identification where skilled user know which data could be used for training or classification and this output layers may vary depends on user needs and number of data-set of each user interface control command from each true wireless sound chip-set architecture.

1. A system for detecting user interface control from True wireless sound system on chip and/or Micro controller unit, the system compromising:
A front end unit; and
A back end unit that sample the data received from the front end then when the data sampling start by the back end cause the system to:
Determine received radio frequency signal, transmitted radio frequency signal and data rate by reading the register values of the true wireless sound base band modem;
To generate filtered sampled data a correction factor processing unit will be required to calibrate the system before the training, by access to non-volatile register map of the true wireless sound system on chip and/or micro-controller units; the filtered data using complex mathematics algorithm will be processing by bitmap change points builder this unique bitmap time series bits will be used as unique sequence for the user interface control command.

2. The system according to claim 1 wherein the bitmap structure table generated, features extracting units that relates to True wireless sound system on chip base-band modem signal will be generated by collecting scattered signal and processing single at the same time.

3. The system according to claim 2, wherein the Tiny machine learning Artificial algorithm used to process the extracted features and compromises:
A artificial neural network (ANN), Edge machine learning.

4. The system according the claim 3, wherein a unique neural network file that contain complex neurons method, that could be loaded inside small true wireless sound system on chip, without compromised the Static random access memory, will be generated as result of training.

5. A method for detecting user interface control command using the true wireless sound base band modem without using any external components, the method compromising:
Neural network file, wherein this file contains all necessary settings and instruction to be loaded inside the instruction decoder of any target true wireless sound system on chip architecture.
Classify the received base band modem signal to nearest predicted command.

6. The method according the claim 5, wherein each movement and/or gesture and/or inter-action between user and true wireless sound earbuds device will be converted and recognize the type of commands without using any external sensor or any relates sensors to detect user interface command.

7. The method according the claim 6, wherein the Base band modem radio frequency of the true wireless sound earbuds chipset and/or system on chip and/or micro-controller unit will be periodically access by the AI processing to convert unseen data sampled to control command using tiny artificial intelligence system and/or unit core.
